(19) United States
(12) Patent Application Publication
(10) Pub. No.: US 2019/0062486 A1
(43) Pub. Date: Feb. 28, 2019

(54) MICROFIBER INTRODUCED IN RIGID FOAM COMPOSED OF POLYURETHANE OR POLYISOCYANURATE APPLIED ON THERMAL INSULATOR PRODUCT

(71) Applicants: ODAIR SALVELINO TEIXEIRA, Vinhedo (BR); Mario NERENBERG, Joinville (BR)

(72) Inventor: Mario NERENBERG, Joinville (BR)

(73) Assignees: ODAIR SALVELINO TEIXEIRA, Vinhedo (BR); Mario SALVELINO NERENBERG, Joinville (BR)

(21) Appl. No.: 15/997,952

(22) Filed: Jun. 5, 2018

(30) Foreign Application Priority Data
Aug. 24, 2017 (BR) BR102017018127

(51) Int. Cl. C08G 18/02; C08G 18/82; C08K 7/02; E04D 1/28

(52) U.S. Cl. CPC C08G 18/022; C08G 18/82; C08G 2101/0025; E04D 1/28; C08K 7/02

(57) ABSTRACT

“MICROFIBER INTRODUCED IN RIGID FOAM COMPOSED OF POLYURETHANE AND POLYISOCYANURATE APPLIED ON THERMAL INSULATOR PRODUCT”, composed by polyurethane and polyisocyanurate in low or high density(2), with introduction of microfibers(3) introduced more directly into the insulating core of the shaped product, type roof tiles and covers(4) of buildings, in order to increase the mechanic resistance of rigid foam structures composed of polyurethane and polyisocyanurate in low and high density, mainly, in low density, enabling a mechanically stronger and much lighter structure for its handling and installation.

### FIELD OF THE INVENTION

The present invention refers to it microfiber introduced in rigid foam composed of polyurethane or polyisocyanurate applied on thermal insulator product, for example, sandwich roof tiles or other product that are best suited for the new composition, in such way to enable higher and better resistance to structures of this gender.

### BACKGROUND OF THE INVENTION

The state of the art present some models of roof tries or sheets composed for roof coverings or division walls grafted with thermal or acoustic insulation material, which use in their filling, eps, polyurethane or polyisocyanurate, that is, the composition of these materials possess high density characteristics, normally between 38 kg/m³-44 kg/m³, in order to obtain mechanic resistance, especially when it comes to roof tiles and covering sheets, in which many times some kind of maintenance is needed, where people end up having to walk on top.

Occur that the high density material is much more expensive, increasing the costs for acquisition and selling of the finished product, also turning the product weight much higher, which directly interfere in the transport, handling and install costs.

### SUMMARY OF THE INVENTION

Thinking about what is known from the state of the art and its difficulties in relation to all that has been quoted above is how was thought in having a microfiber introduced in rigid foam composed of polyurethane or polyisocyanurate applied on thermal insulator product with the objective of increasing the mechanic resistance of rigid foam structures composed of polyurethane or polyisocyanurate in low and high density, mainly in low density, in order to enable a mechanically stronger and much lighter structure for its handling and installation.

Particularly, the microfiber dosage should be of 10% based on the total density of the rigid foam, forming a much stronger material and, consequently, reducing the costs of the finished product, as it would be possible to reduce the required density of the foam from 38 kg/m³-44 kg/m³ to 24 kg/m³-30 kg/m³, drastically decreasing the consumption of polyol in the polyurethane or polyisocyanurate formulas, also, the microfiber dosage can be used from 0 to 10% and still benefit the material.

Another objective of the said invention is to provide a microfiber introduced in rigid foam composed of polyurethane or polyisocyanurate applied on thermal insulator product that can be used in any products for thermal insulation and all his variations, being able to be coated with steel sheet, aluminum, pre-painted steel, aluminum film, synthetic film and stainless steel.

Another objective of the said invention is to provide a microfiber introduced in rigid foam composed of polyurethane or polyisocyanurate applied on thermal insulator product in which the microfiber shapes a core injected at high pressure in the interior of a continuous press, that cures and gives final shape to the product with flexible and metallic coating.

Another objective of the said invention is to provide a microfiber introduced in rigid foam composed of polyurethane or polyisocyanurate applied on thermal insulator product in which the microfiber raw material may be cellulose, derivative of petroleum or any other fibers that suit the product.

Another objective of the said invention is to provide a microfiber introduced in rigid foam composed of polyurethane or polyisocyanurate applied on thermal insulator product that be easy to manufacture and that have reduced costs since the manufacturing process and transportation logistics until the product installation.

### BRIEF DESCRIPTION OF THE DRAWINGS

For further definition and understanding of the invention the following attached figures will be shown, namely:

FIG. 1—Exemplificative view of a product that uses microfiber introduced in rigid foam composed of polyurethane or polyisocyanurate applied on thermal insulator product;

FIG. 2—Exemplificative schematic view of a microscopy showing a microfiber joining in the main mass of an insulator product compound, forming a web, increasing the mechanical resistance of the structure;

FIG. 3—Enlarged microscopic view of the mass of an insulator product compound added of microfibers, shaping a roof tile or a covering sheet;

FIG. 4—Exemplificative view of a product, type metal coating roof tile, with filling of polyurethane or polyisocyanurate foam with introduction and homogenized mixture of microfibers.

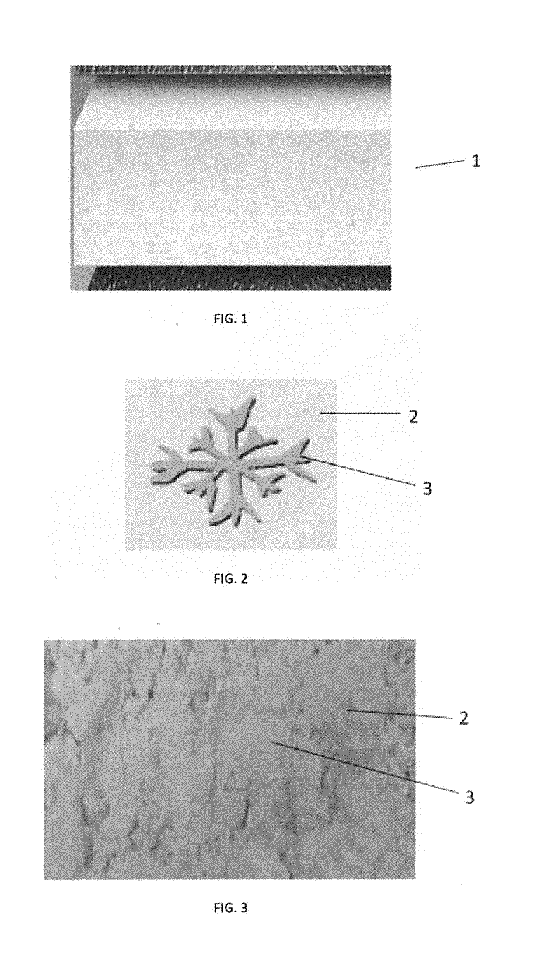

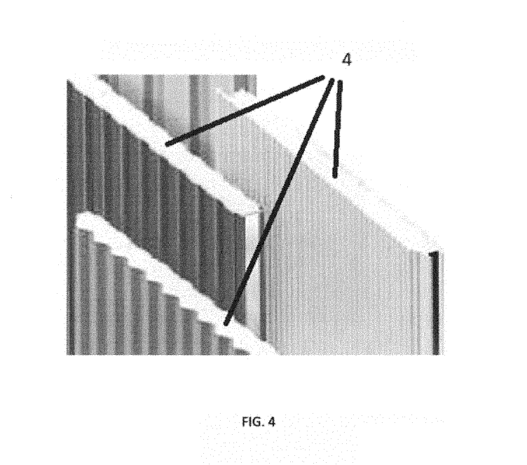

### DETAILED DESCRIPTION OF THE PREFERRED EMBODIMENT

In accordance with the drawnings above specified, referred invention is a microfiber introduced in the structure of a rigid foam product(1), composed by polyurethane or polyisocyanurate in low or high density(2), with introduction of microfibers(3) introduced more directly into the insulating core of the shaped product, type roof tiles and covers(4) of buildings, in order to increase the mechanic resistance of rigid foam structures composed of polyurethane or polyisocyanurate in low and high density, mainly, in low density, enabling a mechanically stronger and much lighter structure for its handling and installation.

What is claimed is:

1. Microfiber introduced in rigid foam composed of polyurethane or polyisocyanurate applied on thermal insulator product, comprising:
Polyurethane or polyisocyanurate in low or high density(2), with introduction of microfibers(3) introduced more directly into the insulating core of the shaped product, type roof tiles and covers(4) of buildings.
